(19) United States
(12) Patent Application Publication
(10) Pub. No.: US 2026/0025725 A1
(43) Pub. Date: Jan. 22, 2026

(54) METHOD AND DEVICE FOR RESISTING SIGNAL INTERFERENCE

(71) Applicant: CyberTAN Technology Inc., Hsinchu (TW)

(72) Inventor: CHUNG-HAO TSAI, Hsinchu (TW)

(21) Appl. No.: 18/777,601

(22) Filed: Jul. 19, 2024

(51) Int. Cl. H04W 36/20; H04L 5/00; H04W 36/06; H04W 72/541

(52) U.S. Cl. CPC H04W 36/20; H04L 5/0048; H04W 36/06; H04W 72/541

(57) ABSTRACT

A method and device for resisting signal interference, comprising a wireless base station receives an interference signal and determines whether the interference signal is a packet interference signal, bandwidth interference signal, or multi-interference signal. Corresponding to the packet interference signal, a first control signal is generated; corresponding to the bandwidth interference signal, a second control signal is generated; or corresponding to the multi-interference signal, a third control signal is generated. Finally, based on the first control signal, the second control signal, or the third control signal, the frequency, radiation pattern, or range of the transmitted signal is adjusted to avoid the interference signal.

### FIELD

The subject matter herein generally relates to an electrical communication technology, particularly a method and device for resisting signal interference used to suppress or limit noise or interference.

### BACKGROUND

With rapid advancements in technology, disciplines such as big data, artificial intelligence, and the internet rely heavily on robust communication technologies as their foundation. Consequently, numerous wireless communication technologies have been developed in the industry to enhance communication speed and throughput, improve communication quality, and support the advancement of technologies like big data, artificial intelligence, and the internet.

Taking the example of wireless distribution system (WDS) technology, it integrates wireless network connections to form a unified network. Multiple wireless access points (APs) communicate wirelessly to create a large-scale network. However, careful planning is essential when positioning wireless access points and determining signal coverage. Improper configuration of wireless access points may lead to mutual interference among signals emitted by multiple APs, thereby affecting overall signal reception quality.

Therefore, inventing a method and device for resisting signal interference would intelligently adjust to avoid interference from other devices, effectively improving the aforementioned issues.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. It will be appreciated that for simplicity and clarity of illustration, where appropriate, reference numerals have been repeated among the different figures to indicate corresponding or analogous elements.

FIG. 1 is a schematic diagram of an embodiment of a wireless distribution system;

FIG. 2 is schematic diagram of an embodiment of a wireless base station;

FIG. 3 is a flowchart of an embodiment of a method for resisting signal interference;

FIG. 4A and FIG. 4B are schematic diagrams of a first embodiment illustrating various states of adjusting transmitted signals;

FIG. 5A and FIG. 5B are schematic diagrams of a second embodiment illustrating various states of adjusting transmitted signals; and

FIG. 6A, FIG. 6B and FIG. 6C are schematic diagrams of a third embodiment illustrating various states of adjusting transmitted signals.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one”.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to;” it specifically indicates open-ended inclusion or membership in the so-described combination, group, series, and the like.

The present invention relates to a method and device for resisting signal interference, which addresses mutual interference among wireless signals. In this embodiment, the method for resisting signal interference can be applied in a wireless distribution system (WDS) to solve the problem of mutual interference among signals emitted by multiple wireless base stations within the system. By employing the method for resisting signal interference of the present invention, adjustments to the coverage range or frequency of the transmitted signals from the wireless base stations can be made based on external or self-collected information, thereby resolving issues of mutual signal interference.

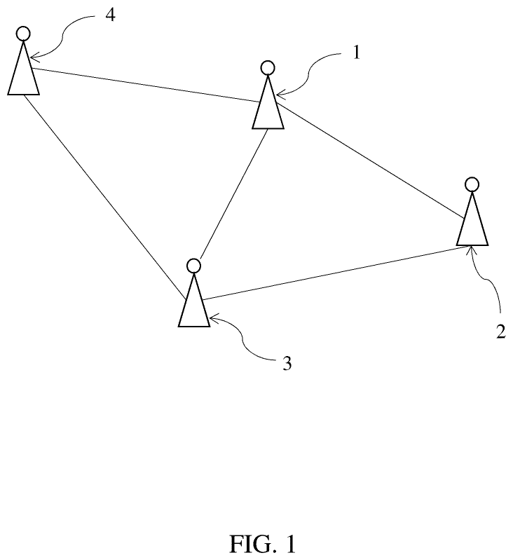

Referring to FIG. 1, which is a schematic diagram of a wireless distribution system, the wireless distribution system consists of multiple wireless base stations 1-4, which communicate wirelessly with each other to form a large-scale network. In this embodiment, the wireless base stations 1-4 can function as access points (APs).

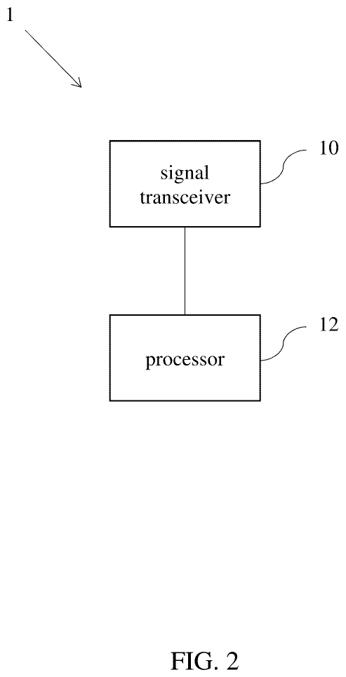

Referring to FIG. 1 and FIG. 2. The method for resisting signal interference can be applied to at least one wireless base station 1 in the wireless distribution system. As shown in FIG. 2, in this embodiment, wireless base station 1 includes a signal transceiver 10 and a processor 12. The signal transceiver 10 is connected to the processor 12. The processor 12 may also be located in the cloud, connected wirelessly to the signal transceiver 10, and is not limited to being located within the wireless base station 1. The signal transceiver 10 consists of antennas and wireless driver controllers for signal transmission and reception, which are known in the art and thus not described in detail. The processor 12 can be a central processing unit (CPU) with an embedded artificial intelligence (AI) module for performing computations according to the method of the present invention. The signal transceiver 10 receives external signals and passes them to the processor 12. After analyzing the external signals, the processor 12 sends corresponding control signals to the signal transceiver 10, the signal transceiver 10 emits wireless signals based on the control from the processor 12.

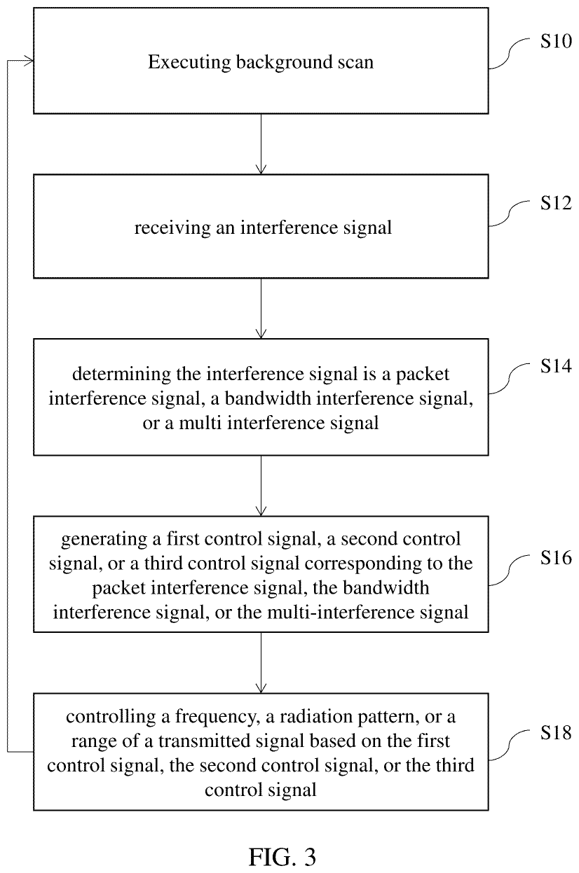

Proceeding with reference to FIG. 3, the method of resisting signal interference of the present invention is explained, comprising steps S10-S18. Beginning with step S10, the processor 12 of the wireless base station 1 controls then the signal transceiver 10 to perform scanning using a background scan technology to detect whether there are interference signals. The interference signals refer to any undesired signals received by the signal transceiver 10 simultaneously with the target signal in the communication system, which adversely affects the signal transceiver 10. In this embodiment, the interference signals may originate from other wireless base stations 2-4.

Next, moving to step S12, when the signal transceiver 10 of the wireless base station 1 receives an interference signal. The signal transceiver 10 passes the interference signal to the processor 12. Then, proceeding to step S14, the processor 12 determines the type of the interference signal, identifying it as a packet interference signal, a bandwidth interference signal, or a multi-interference signal.

The step in which the processor 12 determines the interference signal as the packet interference signal when the processor 12 detects that a signal-to-noise ratio (SNR) is lower than a first preset value, a channel utilization is greater than a second preset value, or a packet error rate (PER) is greater than a third preset value. In this embodiment, the first preset value can be 23 dB, the second preset value can be 75%, and the third preset value can be 0.1%. However, the values of the first preset values, the second preset values, and the third preset values are not limited to the conditions stated above.

The step in which the processor 12 determines the interference signal is a bandwidth interference signal when the processor 12 detects that the interference signal overlapping the bandwidth of the transmitted signal emitted by the signal transceiver 10. The step in which the processor 12 determines the interference signal is the multi-interference signal when the signal transceiver 10 of the wireless base station 1 detecting a number of interference signals.

After the processor 12 distinguishes the type of interference signal, it proceeds to step S16. In step S16, the processor 12 generates control signals corresponding to different types of interference signals. Specifically, the processor 12 generates a first control signal when the interference signal is determined as the packet interference signal, the processor 12 generates a second control signal when the interference signal is determined as the bandwidth interference signal, and the processor 12 generates a third control signal when the interference signal is determined as the multi-interference signal.

Finally, in step S18, the wireless base station 1 adjusts the frequency, radiation pattern, or range of the transmitted signal based on the first control signal, the second control signal, or the third control signal to avoid interference signals.

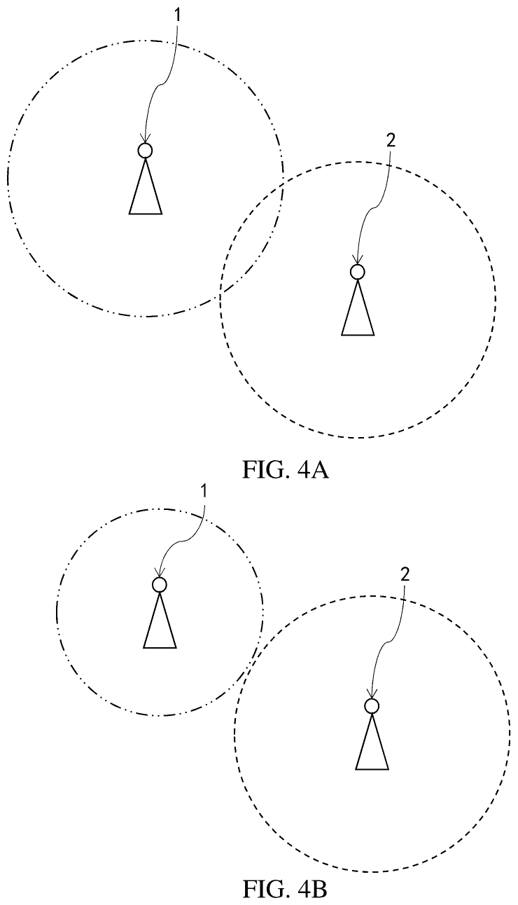

In this embodiment, the first control signal involves adjusting the power of the transmitted signal by reducing it by a fourth preset value to decrease the range of the transmitted signal. In this embodiment, the fourth preset value can be 3 dB. For example, referring to FIG. 4A and FIG. 4B. As shown in FIG. 4A, the transmitted signal from the wireless base station 2 interferes with the transmitted signal from the wireless base station 1. At this point, the processor 12 determines this interference signal to be a packet interference signal and generates the corresponding first control signal. The processor 12 controls the signal transceiver 10 based on the first control signal to reduce the power of the transmitted signal, as illustrated in FIG. 4B. Reducing the power of the transmitted signal can decrease the range of the transmitted signal from the wireless base station 1. Consequently, the wireless signal transmitted by the wireless base station 2 will not interfere with the wireless signal range of the wireless base station 1.

The first control signal can also adjust the frequency of the transmitted signal to be different from that of the interference signal. In this embodiment, the interference signal input from the signal transceiver 10 to the processor 12 includes frequency information of the interference signal. The processor 12 can control the signal transceiver 10 based on this frequency information, adjusting the frequency of the transmitted signal so that it differs from the frequency of the interference signal, thereby preventing mutual interference between the signals.

The second control signal involves the processor 12 of the wireless base station 1 determining the range at which the signal transceiver 10 receives interference signals, and adjusting the radiation pattern of the transmitted signal to avoid the range of the interference signals based on their detected range. Specifically, the processor 12 of the wireless base station 1 determines the range of the interference signals using received signal strength indicator (RSSI) location techniques or channel state information (CSI) location techniques. Once the range of the interference signals is known, the processor 12 can utilize a beamforming technology to control the signal transceiver 10 in adjusting the radiation pattern of the transmitted signal. The beamforming technology adjusts the signal phase and amplitude of each antenna in the antenna array to enhance the signal in a specific direction, thereby achieving directional beam control.

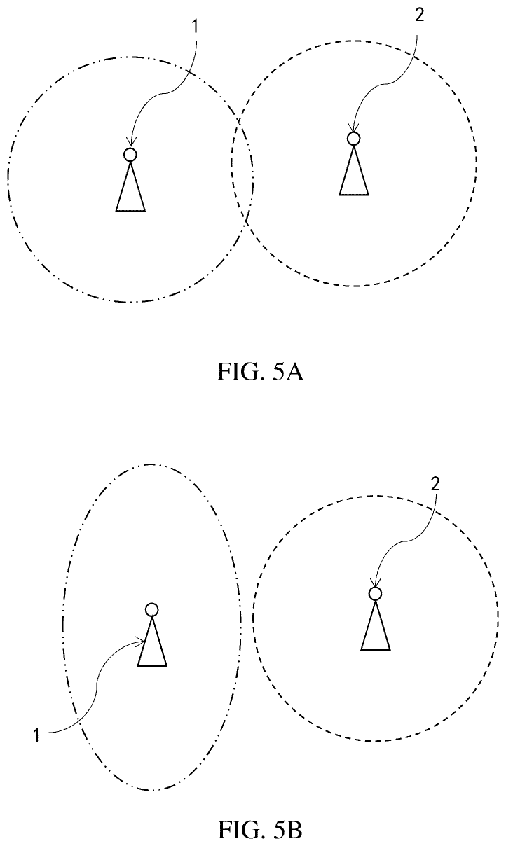

For example, please refer to FIG. 5A and FIG. 5B. As shown in FIG. 5A, interference occurs between the transmitted signals of the wireless base station 2 and the wireless base station 1. At this point, the processor 12 determines that the interference signal is a bandwidth interference signal and generates the corresponding second control signal. Based on the second control signal, the processor 12 controls the signal transceiver 10 to adjust the radiation pattern of the transmitted signal, as depicted in FIG. 5B. The processor 12 determines the range at which the wireless base station 2 emits the interference signal based on the second control signal. The processor 12 then adjusts the radiation pattern of the transmitted signal emitted by the signal transceiver 10 according to the range of the interference signal. In this embodiment, the radiation pattern of the transmitted signal from the wireless base station 1 is adjusted to an elliptical shape. Depending on the circumstances, it can also be adjusted to other shapes, for instance, if the interference signal is surrounding, the radiation pattern might become a smaller circular shape. If the interference signal is on the right side, the radiation pattern would adjust to radiate towards the left side.

The third control signal involves the processor 12 of the wireless base station 1 determining the range of interference signals received by the signal transceiver 10, and adjusting the radiation pattern of the transmitted signal to avoid the range of the interference signals based on their detected range. The techniques for determining the range of the interference signals and adjusting the radiation pattern of the transmitted signal are the same as those in the above the second control signal example. These techniques utilize received signal strength indicator (RSSI) location techniques or channel state information (CSI) location techniques, as well as the beamforming technology, and therefore will not be reiterated here. Additionally, the third control signal may also decrease the transmission power by a fourth preset value to reduce the range of the transmitted signal. In this embodiment, the fourth preset value can be set to 3 dB.

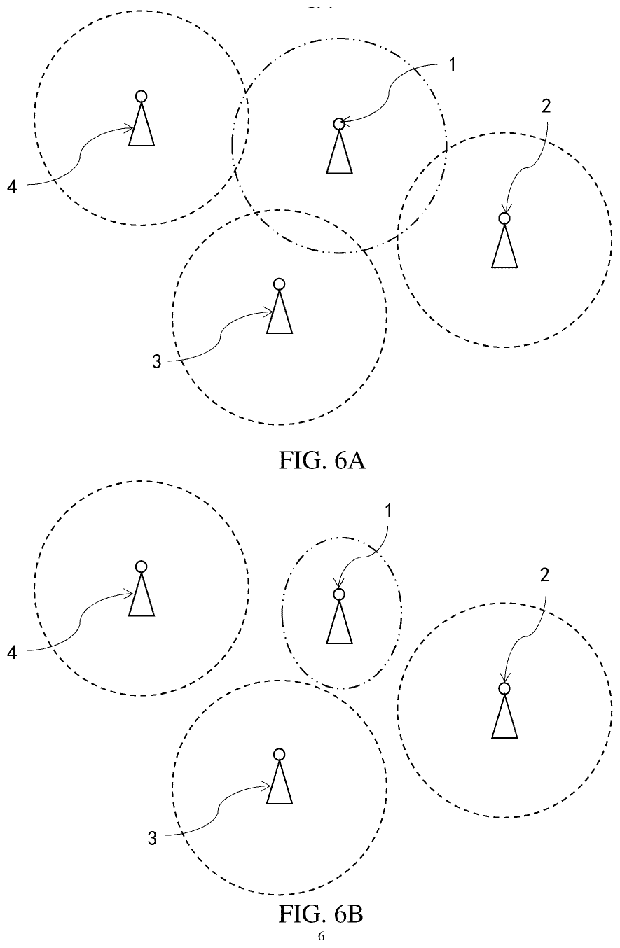

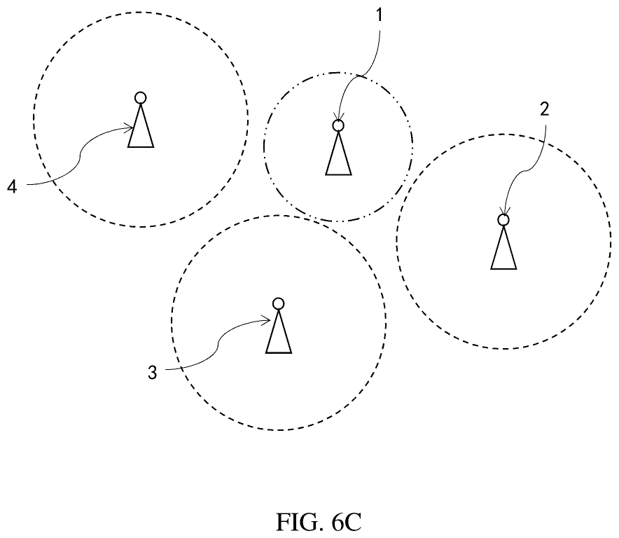

For example, referring to FIG. 6A, FIG. 6B, and FIG. 6C. As shown in FIG. 6A, interference occurs between the transmitted signals of multiple the wireless base stations 2-4 and wireless base station 1. At this point, the processor 12 determines that the interference signal is a multi-interference signal and generates the corresponding third control signal. Based on the third control signal, the processor 12 determines the range of a number of interference signals from the wireless base stations 2-4. The processor 12 then adjusts the radiation pattern of the transmitted signal emitted by the signal transceiver 10 to avoid the range of the interference signals. As depicted in FIG. 6B, the radiation pattern of the transmitted signal can be adjusted to an elliptical shape to avoid the interference signals from the wireless base stations 2-4.

Alternatively, as shown in FIG. 6C, the processor 12 controls signal transceiver 10 to decrease the transmission power, thereby reducing the range of the transmitted signal from the wireless base station 1. In this way, the wireless signals emitted by the wireless base stations 2-4 will not interfere with the wireless signal range of the wireless base station 1.

After completing the above step S18, return to step S10. The signal transceiver 10 of wireless base station 1 continues to perform Background Scan, entering step S12. When interference signals are detected during the scan, steps S14 to step S18 are applied to adjust the transmitted signal gradually to achieve the ideal signal range or frequency. Repeating steps S14 to step S18 recursively allows for a gradual convergence and reduction of the transmission signal range, such as reducing the power by 3 dB at a time, thereby avoiding reducing the signal range too drastically at once, which could affect the communication quality experienced by users.

In summary, the processor described in this case can intelligently handle signal interference issues. It can automatically determine and adjust the coverage range or frequency of the wireless base station signal using external or self-collected information, thereby resolving mutual interference problems between signals.

Many details are often found in the relevant art and many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method for resisting signal interference, the method comprising:
receiving an interference signal by a wireless base station;
determining, by the wireless base station, whether the interference signal is a packet interference signal, a bandwidth interference signal, or a multi-interference signal;
generating, by the wireless base station, a first control signal in response that the interference signal is determined the packet interference signal;
generating, by the wireless base station, a second control signal in response that the interference signal is determined the bandwidth interference signal;
generating, by the wireless base station, a third control signal in response that the interference signal is determined the multi-interference signal; and
controlling, by the wireless base station, a frequency, a radiation pattern, or a range of a transmitted signal to avoid the interference signal based on the first control signal, the second control signal, or the third control signal.

2. The method for resisting signal interference of claim 1, further comprising:
determining, by the wireless station, that the interference signal is the packet interference signal when the wireless base station detects that a signal-to-noise ratio (SNR) is lower than a first preset value, a channel utilization of the transmitted signal is greater than a second preset value, or a packet error rate (PER) is greater than a third preset value.

3. The method for resisting signal interference of claim 1, further comprising:
determining, by the wireless base station, the interference signal is the bandwidth interference signal when the wireless base station detects that a bandwidth of the interference signal overlapping a bandwidth of the transmitted signal.

4. The method for resisting signal interference of claim 1, w further comprising:
determining, by the wireless station, that the interference signal is the multi-interference signal when the wireless base station detects a number of the interference signals.

5. The method for resisting signal interference of claim 1, wherein the first control signal causes the wireless base station to reduce a power of the transmitted signal by a fourth preset value to decrease the range of the transmitted signal, or adjust the frequency of the transmitted signal to be different from a frequency of the interference signal.

6. The method for resisting signal interference of claim 1, wherein the second control signal causes the wireless base station to control the wireless base station to determine a range of the interference signal and to adjust the radiation pattern of the transmitted signal to avoid the range of the interference signal based on the range of the interference signal.

7. The method for resisting signal interference of claim 6, wherein the wireless base station further determines the range of the interference signal by using received signal strength indication (RSSI) location techniques or channel state information (CSI) location techniques to determine the range of the interference signal.

8. The method for resisting signal interference of claim 1, wherein the third control signal causes the wireless base station to control the wireless base station to determine a range of the interference signal, and based on the range of the interference signal, adjusting the radiation pattern of the transmitted signal to avoid the range of the interference signal, or reducing a power of the transmitted signal by a fourth preset value to decrease the range of the transmitted signal.

9. The method for resisting signal interference of claim 6, wherein adjusting the radiation pattern of the transmitted signal is performed by using a beamforming technology.

10. The method for resisting signal interference of claim 1, before receiving the interference signal, the method further comprising detecting the interference signal, by the wireless base station, by using a background scan technology.

11. A device configured for resisting signal interference comprising:
a wireless base station comprising:
a signal transceiver receiving interference signals; and
a processor connected to the signal transceiver, and configured to receiving and determining whether the interference signal is a packet interference signal, a bandwidth interference signal, or a multi-interference signal; generating, by the processor, a first control signal in response that the interference signal is determined as the packet interference signal; generating, by the processor, a second control signal in response that the interference signal is determined as the bandwidth interference signal; generating, by the processor, a third control signal in response that the interference signal is determined as the multi-interference signal, and controlling, by the processor, a frequency, a radiation pattern, or a range of the transmitted signal to avoid the interference signal based on the first control signal, the second control signal, or the third control signal.

12. The device for resisting signal interference of claim 11, wherein the processor determines the interference signal is the packet interference signal, when the processor detects that the signal-to-noise ratio (SNR) of the transmitted signal is lower than a first preset value, the channel utilization is greater than a second preset value, or the packet error rate (PER) is greater than a third preset value.

13. The device for resisting signal interference of claim 11, wherein the processor determines the interference signal is the bandwidth interference signal when the processor detects that the interference signal overlapping the bandwidth of the transmitted signal.

14. The device for resisting signal interference of claim 11, wherein the processor determines the interference signal is the multi-interference signals when the processor, detects a number of interference signals.

15. The device for resisting signal interference of claim 11, wherein the first control signal causes the processor controlling the signal transceiver to reduce a power of the transmitted signal by a fourth preset value to decrease the range of the transmitted signal, or the processor controlling the signal transceiver to adjust the frequency of the transmitted signal to be different from a frequency of the interference signal.

16. The device for resisting signal interference of claim 11, wherein the second control signal causes the processor determining a range of the interference signal and to adjust the radiation pattern of the transmitted signal to avoid the range of the interference signal based on the range of the interference signal.

17. The device for resisting signal interference of claim 16, wherein the processor further determines the range of the interference signal using received signal strength indication (RSSI) location techniques or channel state information (CSI) location techniques.

18. The device for resisting signal interference of claim 11, wherein the third control signal causes the processor determining a range of the interference signal, and based on the range of the interference signal, adjusting the radiation pattern of the transmitted signal emitted by the signal transceiver to avoid the range of the interference signal, or the processor controlling the signal transceiver to reduce the power of the transmitted signal by a fourth preset value to decrease the range of the transmitted signal.

19. The device for resisting signal interference of claim 16, wherein the processor adjusts the radiation pattern of the transmitted signal by using a beamforming technology.

20. The device for resisting signal interference of claim 11, wherein the signal transceiver detects the interference signal by using background scan technology.
